(19) United States
(12) Patent Application Publication
(10) Pub. No.: US 2001/0009930 A1
(43) Pub. Date: Jul. 26, 2001

(54) ELASTOMERIC SHOCK ABSORBING COMPONENT AND METHOD OF MANUFACTURE THEREOF

(76) Inventors: MICHAEL S. LUNT, ABINGTON, CT (US); VINCENT R. LANDI, DANIELSON, CT (US); MURALI SETHUMADHAVAN, FRAMINGHAM, MA (US)

Correspondence Address: CANTOR COLBURN, LLP, 55 GRIFFIN ROAD SOUTH, BLOOMFIELD, CT, 06002

(21) Appl. No.: 09/247,897

(22) Filed: Feb. 10, 1999

(51) Int. Cl. C08L 61/00; C08L 9/00

(52) U.S. Cl. 521/134; 521/135; 521/136

(57) ABSTRACT

A foamed elastomer is presented, manufactured from a foam precursor composition comprising at least one elastomer resin, preferably an ethylene-propylene-diene resin, at least one thermoset resin, preferably a melamine-formaldehyde resin, a curing agent, and a blowing agent. The elastomer composition optionally further includes cure activators, polymerization accelerators, and a filler material. An important feature of the present invention is that the foamed elastomer has a low density and a high modulus, making it particularly suitable as a shock absorber for a bicycle suspension apparatus.

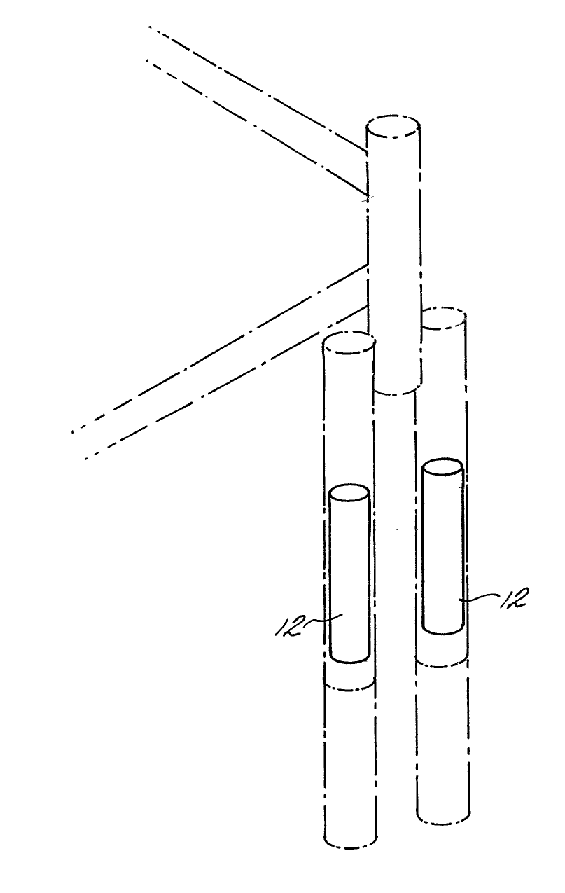

### BACKGROUND OF THE INVENTION

1. Field of the Invention This invention relates generally to the field of foamed elastomers. More particularly, this invention relates to elastomers blended with thermoset resins, the resultant foamed elastomers having high modulus (compressive force deflection). The improved elastomer is particularly suitable for use as a shock absorbing component for bicycles, for example.

2. Description of the Related Art

Foamed elastomers, particularly EPDM elastomers (rubbers) are available for a wide range of uses, from document feed components for electrophotographic devices to wire insulation. As used herein, “EPDM” elastomers refers to terpolymers of ethylene, propylene, and a third diene-containing component. Despite the large body of knowledge regarding foamed elastomers and their uses, there still remains a variety of applications that have not yet been explored.

One such application is shock absorption, which would require elastomers having high modulus (compressive force deflection) and low density. Present shock absorbers for bicycle suspension mounts, for example, presently comprise a hard polyurethane core surrounded by a metal spring. A foamed elastomer, and particularly an EPDM elastomer economical and durable alternative to this configuration. However, no elastomers are currently available which have the requisite density and high modulus required for such shock absorption applications. Preferred materials would furthermore be resistant to light, heat, ozone, and weather, and have excellent compression set resistance. The elastomers should ideally be able to undergo an up to 50% deflection and not take compression set exceeding 20%.

One common approach for increasing the modulus of elastomers is by the addition of reinforcing fillers such as carbon black as disclosed, for example, in U.S. Pat. No. 5,700,845. However, addition of such fillers to elastomers in the quantities required to achieve a high modulus leads to significant increases in the viscosity of the foam precursor composition, which in turn leads to significant processing difficulties. High viscosity also present difficulties in foaming, and thus leads to high-density foams. Accordingly, there remains a need in the art for a foamed elastomer that possesses low density, a high modulus, excellent compression set resistance, and excellent resistance to light, heat, ozone, and weather.

### SUMMARY OF THE INVENTION

The above-described and other problems and deficiencies of the prior art are overcome or alleviated by the foamed elastomer and method for manufacturing the same of the present invention, manufactured from a foaming composition comprising at least one elastomer rubber, at least one thermoset resin, a blowing agent, and a curing agent. The blowing agent may be the same or different as one of the other precursor foam components. In addition, the present invention preferably includes cure activators, polymerization accelerators, foaming agents and at least one filler. A preferred foaming composition comprises an EPDM elastomer and a melamine-formaldehyde resin. In important feature of the present invention, the thermoset resin confers the advantages of low density and high modulus to the product foam.

In one embodiment, an EPDM elastomer of the present invention is used as a shock absorber for a bicycle suspension mount, for example, having a low density and high hardness, as well as excellent resistance to ultraviolet light, heat, ozone, and weather. These and other features will become better understood with reference to the following detailed description, drawings, and appended claims.

### BRIEF DESCRIPTION OF THE DRAWINGS

For the purpose of illustrating the invention, there are shown in the drawing forms which are presently preferred; it being understood that this invention is not limited to the precise arrangements and instrumentalities shown. Referring now to the drawing, the

FIGURE is a side elevational view of an EPDM elastomer bicycle suspension shock absorber of the present invention, with the bicycle components shown in shadow.

### DETAILED DESCRIPTION OF THE INVENTION

A high modulus, low density, low compression set elastomer foam is manufactured from a foaming composition comprising at least one elastomer, at least one thermoset resin, a blowing agent, and a curing agent. The blowing agent may be the same or different as one of the other foaming composition components. In addition, the present invention optionally includes cure activators, polymerization accelerators and a filler. In an important feature of the present invention, the presence of a thermoset resin provides for a low density, high modulus elastomeric foam. Each component is discussed in more detail below.

Elastomers

Elastomers suitable for use with the present invention form flexible foams and are preferably crosslinkable by free radicals. Suitable elastomers include, but are not limited to, polybutadienes, styrene-butadiene rubbers, nitrile rubbers, polyisoprenes, epichlorohydrins, EPDM rubbers, and the like.

A preferred EPDM elastomeric component is a terpolymer of ethylene, propylene, and a diene monomer. Suitable EPDM elastomers are ethylene-propylene-diene terpolymers wherein the diene component includes but is not limited to those such as ethylidene norbornene, (ENB), dicyclopentadiene, and 1,4-hexadiene. One suitable elastomer is a mixture of an ethylene-propylene-diene terpolymer wherein the diene is ethylidene norbornene, which is commercially available under the trade name Royalene 645 from the Uniroyal Chemical Company, and an ethylene-propylene-diene terpolymer wherein the diene is ethylidene norbornene, which is commercially available under the trade name Royalene 509 from the Uniroyal Chemical Company. Preferred EPDM resins have higher reactivity (higher unsaturation) and good compatibility with the range of thermoset resins used. Other EPDM resins are also suitable, including that sold under the trade name Royalene 535.

The elastomer is present in amounts in the range from about 20 to about 70 pph (parts per hundred), and more preferably, in an amount in the range from about 35 to about 45 pph.

Thermoset Resin

Thermoset resins suitable for use with the present invention provide the requisite modulus without adversely affecting other elastomer resin characteristics such as foamability, curability, processability, density of the produced foams, weatherability, and the like. They should co-cure with the elastomer resin, exhibit good heat resistance, compression set resistance, low moisture adsorption, and good dimensional stability. Suitable thermoset resins include, but are not limited to, melamine-formaldehyde, urea-formaldehyde and phenol-formaldehyde.

The at least one elastomer rubber or rubber mixture is preferably compounded with a melamine-formaldehyde resin. As used herein, melamine-formaldehyde refers to that class of polymers formed by the condensation reaction of melamine (2,4,6-triamino-s-triazene) with formaldehyde. Melamine-formaldehyde resins are hard thermosets, generally having a Rockwell Hardness in the range of M 118 to 124. A suitable melamine-formaldehyde resin is commercially available under the trade name MF-415 from BTLSR Toledo Inc., Toledo, Ohio.

The thermoset resin is present in amounts ranging from about 2.5 to about 55 pph, and preferably from about 5 to about 15 pph.

Curing Agent

The composition of the present invention further includes a curing agent, usually in the form of a peroxide, sulfur, or sulfur derivative. Peroxide vulcanization occurs when the composition is heated and the peroxide decomposes to form free radicals, which can then initiate crosslinking of the polymeric chains. Preferred peroxide curing agents are free radical cure initiators such as organic peroxides, e.g. dicumyl peroxide, p,p″-bis(t-butylperoxy)diisopropylbenzene, or 2,5-di(t-butyl-peroxy)hexane. Sulfur, an alternative curing agent, creates bridges between the rubber chains during the vulcanization process and is the preferred curing agent in accordance with the present invention. Other suitable curing agents are ethylene thiourea, 2,5 dimercapto-1,3,4-thiazole, trithiocyanuric acid, and 2,4,6-trimercapto-s-triazine.

The curing agent is provided in an amount of between about 0.5 to about 15.0 pph and more preferably, in an amount of about 5 pph.

Blowing Agent

Blowing agents, sometimes referred to as foaming agents, generate cells in polymeric materials. During the expansion of the substrate by the blowing agent, cells are initiated and grow to produce the final foam. Preferred blowing agents are known in the art, for example azodicarbonamides, one of which is available under the trade name Celogen 765 (a modified activated azodicarbonamide commercially available from Uniroyal Chemical Company), p,p′-oxybis(benzenesulfonyl hydrazide), p,p-oxybis(N-nitroso-N-methyl)benezenesulfonamide, or sodium bicarbonate. The blowing agent is present in an amount of between about 2 to about 12 pph, and more preferably, in an amount of about 7 pph. Under certain conditions, one or more of the other precursor foam components may act as a blowing agent. For example, when melamine-formaldehyde is cured in a sufficiently acidic environment, it acts as the main foaming agent and cell generating component of the system.

Cure Activator

A cure activator may optionally be included in the composition. Preferred activators are known in the art, and include metal oxides, e.g. zinc oxide, and metal stearates. A preferred cure activator is a zinc oxide available under the trade name Elastozinc from Elastochem Inc. The activator is provided in an amount of between about 1 to about 10 pph.

Cure Accelerators

The composition may optionally include a cure accelerator. The polymerization accelerators suitable for use in the present invention include sulfides, for example mercaptobenzothiazole disulfide (MBTS). Other suitable accelerators are tetramethylthiuram monosulfide (TMTM), tetraethylthiuram disulfide, tetramethylthiuram disulfide (TMTD), zinc di-n-butyldithiocarbamate, dipentamethylenethiuram hexasulfide and zinc di-n-methyldithiocarbamate.

If present, the accelerator is preferably used in an amount in the range from about 0.1 to about 5 pph.

Filler

The composition further optionally includes at least one filler. The addition of smaller quantities of a filler reinforces the elastomer and improves the processability of the elastomer. Examples of preferred fillers include carbon blacks, e.g., N990 carbon black and N550 carbon black (commercially available from Cabot Manufacturing and R. T. Vanderbilt Company, respectively), diatomaceous earth, clay, alumina, talc, silica, and calcium carbonate. Carbon black compositions are particularly preferred. Non-carbon black fillers used in conjunction with organosilane coupling agents, such as Si-69 From DeGussa Corporation may be used as a suitable replacement for the carbon black.

If a filler used, it is present in amounts in the range from about 5 to about 100 pph.

Referring now to the FIGURE, the shock absorber for a bicycle suspension unit comprises a cylinder 12 of the EPDM elastomer of the present invention. For shock-absorbing applications, the elastomer foam has a density range, compressive force deflection (CFD) values, and compression set (C-set) which will result in effective shock absorption, such values being empirically determined for the particular application. Preferred values are set forth in Table 1 below:

TABLE 1

| | | | | Most |
|---|---|---|---|---|
| | | | Preferred | Preferred |
| Property | Test Method | Range | Range | Range |
| Density, lbs/ft³ | ASTM D3574-77 | <50 | 15-50 | 25-35 |
| CFD at 25%, lbs/inch² | ASTM D3574-77 | >20 | 20-1500 | 750-1250 |
| CFD at 50%, lbs/inch² | ASTM 3574-77 | >140 | 140-5000 | 1250-3000 |
| C-set, % original | 22 hours at 70° C. | <20 | <15 | <10 |
| Brabender Viscosity | * | 500-3500 | 1200-2400 | 1500-1800 |

*270 cc volume loading; 25 rpm at 75° C.; reading taken at 10 minutes

The elastomer foams may be manufactured by methods known to those of ordinary skill in the art. In the manufacture of a shock absorbing cylinder, for example, all components except for the cure initiators, accelerators and blowing agents are mixed, for example in a Brabender mixer, or roll milled in a Banbury miller, ensuring that the temperature does not rise above about 130° C. The cure initiators, accelerators, and blowing agents are then added and mixed, ensuring that the temperature does not rise above about 75° C. The material is then extruded at a temperature in the range from about 100° F. (38° C.) to below about 195° F. (91° C.) as a solid rod form, or as a tube, and cut to various lengths, for example 10 inches. The rods are then placed in an oven or mold and cured, for example at about 350° F. (177° C.) for 10 to 30 minutes to cause blowing of the elastomer. A post-cure step may be necessary to ensure complete cure. The precise conditions are empirically determined, and are adjusted to achieve a desired target foamed elastomer density and degree of cure.

The following non-limiting examples further describe elastomers of the present invention.

### EXAMPLES

Procedures

Chemicals, sources, and descriptions are listed in Table 2 below.

TABLE 2

| Trade Name | Source | Description |
|---|---|---|
| Royalene 645 | Uniroyal Chemical Co. | Ethylene propylene diene terpolymer resin |
| Royalene 535 | Uniroyal Chemical Co. | Ethylene propylene diene terpolymer resin |
| Royalene 509 | Uniroyal Chemical Co. | Ethylene propylene diene terpolymer resin |
| MF-415 | BTLSR Toledo Ohio | Melamine-formaldehyde resin |
| N660 | Cabot Company | Carbon black filler |
| N550 | RT Vanderbilt Co. Inc. | Carbon black filler |
| N990 | RT Vanderbilt Co. Inc. | Carbon black filler |
| Elastozinc | Elastochem Inc. | Zinc oxide |
| Emersol 132 | C. P. Hall Company | Combination of stearic acid/adipic acid |
| MBTS | R. T. Vanderbilt | Thiazole |
| Butazate | Uniroyal Chemical Co. | Zinc dibutyldithiocarbamate |
| Sulfads | R. T. Vanderbilt Co. | Dipentamethylenethiuram hexasulfide |
| RM98D | Reagent Chemical and | Sulfur |
| | Research Inc. | |
| Celogen 765 | Uniroyal Chemical Co. | Modified activated azodicarbonamide |
| Sunpar 2280 | Sun Petroleum | Paraffin oil |
| Kadox 911C | Uniroyal Chemical Co. | Thiuram |
| Natsyn | Goodyear | Polyisoprene rubber |
| Altax | RT Vanderbilt Co. Inc. | Benzothiazyl disulfide |

Preferred compositions and ranges are shown in the Table 3 below, with the proviso that the one or more elastomer (rubber) components total one hundred parts by weight.

TABLE 3

| Component | Range, phr* | Preferred Range, phr* |
|---|---|---|
| Royalene 535 | 0-100 | 0-100 |
| Royalene 509 | 0-100 | 0-100 |
| Royalene 645 | 0-100 | 0-100 |
| Natsyn | 0-100 | 0-100 |
| MF-415 | 5-400 | 15-250 |
| N550 | 5-100 | 30-70 |
| N660 | 5-100 | 30-70 |
| N990 | 5-100 | 30-70 |
| Elastozinc | 1-10 | 5-8 |
| Emersol 132 | 1-5 | 2-3 |
| MBTS | 0.25-3 | 0.5-1 |
| Butazate | 0.1-5 | 2.5-3.5 |
| Sulfads | 0.1-2 | 0.5-0.75 |
| RM98D | 0.5-25 | 3-7 |
| Celogen 745A | 0-15 | 4-8 |
| Kadox 911 | 1-20 | 5-8 |
| Sunpar 2280 | 0-50 | 0-20 |
| Altax | 0.1-3 | 0.25-1 |

*parts per hundred of elastomeric (rubber) component(s) by weight

Samples 1-8 were produced wherein the components shown in Table 4 (except for the cure initiators, accelerators, and blowing agents) were mixed, for example in a Brabender mixer, or roll milled in a Banbury miller, ensuring that the temperature did not rise above about 130° C. The cure initiators, accelerators, and blowing agents were then added and mixed, ensuring that the temperature does not rise above about 75° C. The material was then extruded at a temperature in the range from about 135° F. and below 195° F. (° C.) as a solid rod form, or as a tube, and cut to various length, for example 10 inches. The rods were then placed into an oven and cured, for example at about 350° F. for 10 to 30 minutes to cause blowing and of the elastomer.

TABLE 4

| | Sample No. | | | | | | | |
|---|---|---|---|---|---|---|---|---|
| Component | 1** | 2 | 3 | 4 | 5 | 6 | 7** | 8 |
| Royalene 535 | 100 | 100 | 100 | 100 | 100 | 100 | 100 | 0 |
| Natsyn | 0 | 0 | 0 | 0 | 0 | 0 | 0 | 100 |
| MF-415 | 0 | 5 | 30 | 270 | 400 | 270 | 30 | 50 |
| N550 | 0 | 0 | 0 | 30 | 25 | 30 | 270 | 75 |
| N660 | 18.1 | 15 | 15 | 0 | 0 | 0 | 0 | 0 |
| N990 | 14.5 | 0 | 0 | 0 | 0 | 0 | 0 | 0 |
| Elastozinc | 6.7 | 6.5 | 6.5 | 0 | 0 | 0 | 0 | 0 |
| Emersol 132 | 1.5 | 2 | 3 | 3 | 3 | 3 | 3 | 5 |
| MBTS | 1.2 | 1.2 | 1.2 | 0 | 0 | 0 | 0 | 0 |
| Butazate | 1.5 | 1.5 | 1.5 | 3 | 3 | 3 | 3 | 3 |
| Sulfads | .6 | .6 | .6 | .75 | .75 | .75 | .75 | 0.75 |
| RM98D | 3 | 3 | 3 | 1.5 | 1.5 | 1.5 | 1.5 | 5 |
| Celogen 745A | 8 | 8 | 2 | 0 | 8 | 0 | 8 | 6 |
| Kadox 911 | 0 | 0 | 0 | 8 | 8 | 8 | 8 | 5 |
| Sunpar 2280 | 0 | 0 | 0 | 20 | 60 | 20 | 120 | 20 |
| Altax | 0 | 0 | 0 | 0 | .25 | .25 | .25 | 0 |

**Comparative Samples

The physical properties for each of the above Samples 1-8 are shown in Table 5 below:

TABLE 5

| | Sample No. | | | | | | | |
|---|---|---|---|---|---|---|---|---|
| Property | 1** | 2 | 3 | 4 | 5 | 6 | 7** | 8 |
| Density, lbs/ft³ | 16.9 | 28.6 | 29.1 | 31.9 | 31.2 | 44.7 | 79.8 | 43.1 |
| CFD at 25%, lbs/inch² | 8 | 43 | 102 | 200 | 180 | 1020 | 1210 | 163 |
| CFD at 50%, lbs/inch² | 29 | 139 | 254 | 780 | 710 | 3850 | 3010 | 2970 |
| C-set, % original | 7.8 | 4.5 | 4.1 | 3.3 | 5.5 | 3.9 | 14.2 | 4.6 |
| Brabender Viscosity | 1050 | 1180 | 970 | 930 | 950 | 980 | >4000* | 910 |

*Broke pin during testing
**Comparative samples

As shown by the above data, blends of elastomers with thermoset resins results in elastomers having improved modulus and decreased density compared with Sample 1, which has no thermoset resin. Addition of thermoset resins to the foaming composition actually decreased the viscosity of the composition, resulting in better processability. Comparative Sample 7 demosntrates that addition of high quantities of filler results in the formation of resins which are too viscous.

The elastomer disclosed hereing is aptly suited for uses requiring low density and high modulus. These advantageous properties make it particularly suitable for use as a shock absorber for a bicycle suspension mount, providing a commercially attractive alternative to present materials. While preferred embodiments have been shown and described, various modifications and substitutions may be made thereto without departing from the spirit and scope of the invention. Accordingly, it is understood that the present invention has been described by way of illustrations and not limitation.

What is claimed is:

1. A foaming composition for the manufacture of a foamed elastomer comprising:
an elastomer component;
a thermoset resin component;
a blowing agent which may be the same or different as the other components; and
a curing agent.

2. The foaming composition of claim 1, wherein:
the elastomer component is selected from the group consisting of polybutadiene, styrene-butadiene rubber, nitrile rubber, polyisoprene, epichlorohydrin, and ethylene propylene diene terpolymer wherein the diene is selected from the group consisting of ethylidene norbornene, dicyclopentadiene, and 1,4-hexadiene, and a combination thereof.

3. The foaming composition of claim 1, wherein:
the elastomer resin component comprises a first ethylene-propylene-diene terpolymer wherein the diene is ethylidene norbornene, and a second ethylene-propylene-diene terpolymer wherein the diene is dicyclopentadiene.

4. The foaming composition of claim 1, wherein:
the thermoset resin component is selected from the group consisting of melamine-formaldehyde, phenol-formaldehyde, urea formaldehyde, and a combination thereof.

5. The foaming composition of claim 1, wherein:
the curing agent is an organic peroxide, sulfur, a sulfur derivative, or a combination thereof.

6. The foaming compositon of claim 1, wherein:
the blowing agent is an azodicarbonamide, p,p′-oxybis(benzenesulfonyl hydrazide), p,p-oxybis(N-nitroso-N-methyl)benezenesulfonamide, sodium bicarbonate, melamine-formaldehyde, or a combination thereof.

7. The foaming composition of claim 1, further comprising:
an accelerator, a cure activator, a filler, or a combination thereof.

8. The foaming composition of claim 7, wherein:
the cure activator is a metal oxide or metal stearate.

9. The foaming composition of claim 7, wherein:
the accelerator is a sulfide or dithiocarbamate.

10. The foaming composition of claim 7, wherein:
the accelerator is tetramethylthiuram disulfide, tetramethylthiuram monosulfide, tetraethylthiuram disulfide, mercaptobenzothiazole disulfide, zinc di-n-butyldithiocarbamate, zinc dimethyldithiocarbamate, or a combination thereof.

11. The foaming composition of claim 7, wherein:
the filler is carbon black, diatomaceous earth, clay, alumina, talc, silica, calcium carbonate, or a combination thereof.

12. The foaming composition of claim 11, wherein:
the filler is carbon black.

13. A foaming composition for the manufacture of a foamed elastomer comprising:
an EPDM elastomer component or a polyisoprene elastomer component;
a thermoset resin component;
a blowing agent which may be the same or different as the other components; and
a curing agent.

14. The foaming composition of claim 13, wherein:
the elastomer component is an ethylene propylene diene terpolymer wherein the diene is selected from the group consisting of ethylidene norbornene, dicyclopentadiene, and 1,4-hexadiene.

15. The foaming composition of claim 13, wherein:
the elastomer component comprises a first ethylene-propylene-diene terpolymer wherein the diene is ethylidene norbornene, and a second ethylene-propylene-diene terpolymer wherein the diene is dicyclopentadiene.

16. The foaming composition of claim 13, wherein:
the thermoset resin is selected from the group consisting of melamine-formaldehyde, phenol-formaldehyde, urea-formaldehyde, and combinations thereof

17. The foaming composition of claim 13, wherein:
the curing agent is an organic peroxide, sulfur, a sulfur derivative, or a combination thereof.

18. The foaming composition of claim 13, wherein:
the blowing agent is an azodicarbonamide, p,p′-oxybis(benzenesulfonyl hydrazide), p,p-oxybis(N-nitroso-N-methyl)benezenesulfonamide, sodium bicarbonate, melamine-formaldehyde, or a combination thereof.

19. The foaming composition of claim 13, further comprising:
at least one of an accelerator, a cure activator, a filler, or a combination thereof.

20. The foaming composition of claim 19, wherein:
the cure activator is a metal oxide or metal stearate;
the accelerator is a sulfide or dithiocarbamate;
the accelerator is tetramethylthiuram disulfide, tetramethylthiuram monosulfide, tetraethylthiuram disulfide, mercaptobenzothiazole disulfide, zinc di-n-butyldithiocarbamate, zinc dimethyldithiocarbamate, or a combination thereof; and
the filler is carbon black, diatomaceous earth, clay, alumina, talc, silica, calcium carbonate, or a combination thereof.

21. A foamed elastomer manufactured from a composition comprising:
an EPDM elastomer component or a polypropylene elastomer component;
a melamine-formaldehyde resin component;
a blowing agent which may be the same as another component; and
a curing agent.

22. The elastomer of claim 21, wherein:
the curing agent is an organic peroxide, sulfur, a sulfur derivative, or a combination thereof.

23. The elastomer of claim 21, wherein:
the blowing agent is azodicarbonamides, p,p′-oxybis(benzenesulfonyl hydrazide), p,p-oxybis(N-nitroso-N-methyl)benezenesulfonamide, sodium bicarbonate, melamine-formaldehyde, or a combination thereof.

24. The elastomer of claim 21, further comprising:
an accelerator, a cure activator, a filler, or a combination thereof.

25. The elastomer of claim 24, wherein:
the cure activator is a metal oxide or metal stearate;
the accelerator is tetramethylthiuram disulfide, tetramethylthiuram monosulfide, tetraethylthiuram disulfide, mercaptobenzothiazole disulfide, zinc di-n-butyldithiocarbamate, zinc dimethyldithiocarbamate, or a combination thereof; and
the filler is carbon black, diatomaceous earth, clay, alumina, talc, silica, calcium carbonate, or a combination thereof.

26. A method of making a foamed elastomer comprising:
providing a precursor solution comprising an elastomer component, a thermoset resin component, a blowing agent wherein the blowing agent may be the same as another component, and a curing agent;
foaming the elastomer precursor solution; and
curing the foamed solution.

27. The method of claim 26, wherein:
the elastomer resin component is selected from the group consisting of polybutadiene, styrene-butadiene rubber, nitrile rubber, polyisoprene, epichlorohydrin, an ethylene propylene diene terpolymer wherein the diene is selected from the group consisting of ethylidene norbornene, dicyclopentadiene, and 1,4-hexadiene, and a combination thereof.

28. The method of claim 26, wherein:
the elastomer resin component is selected from the group consisting of polyisoprene, an ethylene-propylene-diene terpolymer elastomer rubber, and a first ethylene-propylene-diene terpolymer wherein the diene is ethylidene norbornene, and a second ethylene-propylene-diene terpolymer wherein the diene is dicyclopentadiene.

29. The method of claim 26, wherein:
the thermoset resin component is selected from the group consisting of melamine-formaldehyde, phenol-formaldehyde, urea-formaldehyde, and a combination thereof

30. The method of claim 26, wherein:
the curing agent is an organic peroxide, sulfur, a sulfur derivative, or a combination thereof.

31. The method of claim 26, wherein:
the blowing agent is an azodicarbonamide, p,p′-oxybis(benzenesulfonyl hydrazide), p,p-oxybis(N-nitroso-N-methyl)benezenesulfonamide, sodium bicarbonate, melamine-formaldehyde, or a combination thereof.

32. The method of claim 26, wherein:
the precursor solution further comprises at least one of an accelerator, a cure activator, a filler, or a combination thereof.

33. The method of claim 32 wherein:
the cure activator is a metal oxide or metal stearate;
the accelerator is a sulfide or dithiocarbamate;
the accelerator is tetramethylthiuram disulfide, tetramethylthiuram monosulfide, tetraethylthiuram disulfide, mercaptobenzothiazole disulfide, zinc di-n-butyldithiocarbamate, zinc dimethyldithiocarbamate, or a combination thereof; and
the filler is carbon black, diatomaceous earth, clay, alumina, talc, silica, calcium carbonate, or a combination thereof.

34. A shock absorber comprising the foamed elastomer of claim 1.

35. The shock absorber of claim 34, wherein the shock absorber is for a bicycle suspension unit.

36. A shock absorber comprising the foamed elastomer of claim 13.

37. The shock absorber of claim 36, wherein the shock absorber is for a bicycle suspension unit.

38. A shock absorber comprising the elastomer of claim 21.

39. The shock absorber of claim 38, wherein the shock absorber is for a bicycle suspension unit.
